(19) United States
(12) Patent Application Publication
(10) Pub. No.: US 2008/0179475 A1
(43) Pub. Date: Jul. 31, 2008

(54) Projector mount

(75) Inventors: Andy Whitley, Lake in the Hills, IL (US); Derrik Lam, Cicero, IL (US); Marcus Willi Karl Gerhard Bosch, Chicago, IL (US)

Correspondence Address: FOLEY & LARDNER LLP, 321 NORTH CLARK STREET, SUITE 2800, CHICAGO, IL, 60610-4764, US

(73) Assignee: Peerless Industries, Inc.

(21) Appl. No.: 12/009,304

(22) Filed: Jan. 17, 2008

Related U.S. Application Data
(60) Provisional application No. 60/881,807, filed on Jan. 19, 2007.

(51) Int. Cl. F16M 11/00; A47G 29/00

(52) U.S. Cl. 248/218.4; 248/323

(57) ABSTRACT

A low profile projector mount for media projectors, enabling images of a media projector to be sufficiently aligned with a projection screen upon which the images are to be displayed. The alignment of the low profile projector mount is achieved through pitch, roll, and/or yaw adjustment mechanisms incorporated into the low profile projector mount. The low profile projector mount can be flush mounted to a ceiling or attached to an extension column or other intermediary support system. A quick-release system allows a projector attached to the low profile, projector mount to be removed without disturbing the low profile, projector mount. In addition, retractable members for effectuating the pitch, roll, and/or yaw adjustments are utilized.

### CROSS-REFERENCE TO RELATED APPLICATIONS

The present application claims priority to U.S. Provisional Patent Application No. 60/881,807, filed Jan. 19, 2007.

### FIELD OF THE INVENTION

The present invention relates generally to mounting systems. More particularly, the present invention relates to mounting systems for use with devices such as media projectors.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Display devices such as media projectors offer an alternative to traditional cathode ray tube (CRT) televisions and monitors, and more recently to flat panel displays such as liquid crystal display (LCD) and plasma screen televisions and monitors. Media projectors operate by projecting a display either onto a projection screen or from behind a projection screen. Positioning a media projector to project a display onto a display screen traditionally required placing the media projector on a table or other surface at a required distance from the display screen. Because the required distance could put the media projector behind viewers situated in front of the projection screen, it was a common occurrence for a viewer to inadvertently block the display being projected from the media projector. Therefore, positioning a media projector on a table or similar surface was undesirable.

To prevent having viewers or other objects inadvertently block the projected display, ceiling-mounted projectors were developed. However, conventional projector mounts are often large and unwieldy to install, require ample ceiling support, and are visually unappealing. In particular, conventional projector mounts use a plurality of fasteners, thus requiring the use of tools to adjust for positioning the media projector and for positioning the conventional projector mount itself. For example, a special installer is oftentimes required to re-adjust image alignment of the media projector, for example, and for removing a media projector from the conventional projector mount in order to service the media projector. Furthermore, the plurality of fasteners tended to easily slip or move out of alignment when adjusting the conventional projector mounts. In addition, conventional projector mounts do not provide an easy and convenient system and method of making necessary adjustments to enable the display being cast to be satisfactorily aligned with the projector screen.

### SUMMARY OF THE INVENTION

Various embodiments of the present invention provide a projector mount for use with a variety of devices, especially media projectors. A media projector is operatively connected to a connection block, for example, via an adapter, where the connection block is then engaged with a projector mount body. The projector mount body in turn can be flush mounted to a ceiling or similar support structure. Alternatively, the projector mount body can be attached to an extension column at a first end, where a second end of the extension column is attached to the ceiling or similar support structure. The projector mount enables images of a media projector to be sufficiently aligned with a projection screen upon which the images are to be displayed. The alignment of the projector mount is achieved through pitch and roll adjustment mechanisms incorporated into the projector mount utilizing worm gears working in conjunction with worms. Use of the worm gears provides easy yet secure adjustment of the projector mount. Alternatively, lead screws can be used in place of the worms to effectuate the same adjustment mechanisms. Alignment of the projector mount with regard to yaw to achieved by manually rotating the projector mount.

The various embodiments of the present invention allow for an aesthetically clean and pleasing appearance to ceiling mounted media projectors. Installation of the projector mount and the media projector attached thereto is convenient, as is configuring and adjusting the projector mount and the media projector according to desired yaw, pitch, roll, and height. Fewer are needed for installing and no tools are necessary for adjusting the projector mount, where any adjustments made to the projector mount are securely maintained. In addition, the worm gear adjustment mechanisms allow for more precise adjustments on a smaller scale than previously provided.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a top view of a projector mount constructed in accordance with various embodiments of the present invention;

FIG. 2 is a first side view of the projector mount of FIG. 1;

FIG. 3 is a second side view of the projector mount of FIG. 1;

FIG. 4 is a third side view of the projector mount of FIG. 1;

FIG. 5 is a bottom view of the projector mount of FIG. 1;

FIG. 6 is a first perspective view of the projector mount of FIG. 1;

FIG. 7 is a second perspective view of the projector mount of FIG. 1;

FIG. 8 is a third perspective view of the projector mount of FIG. 1;

FIG. 9 is a fourth perspective view of the projector mount of FIG. 1;

FIG. 10 is fourth side view of the projector mount of FIG. 1;

FIG. 11 is a first cutout side view of the projector mount of FIG. 1;

FIG. 12 is a second cutout side view of the projector mount of FIG. 1;

FIG. 13 shows a method of installing an extension column onto the projector mount of FIG. 1; and

FIG. 14 shows a perspective view of an adapter for use in conjunction with the projector mount of FIG. 1.

### DETAILED DESCRIPTION OF THE PREFERRED EMBODIMENTS

The various embodiments of the present invention provide a projector mount in which a media projector can be conveniently and easily mounted. The projector mount can be adjusted via a plurality of adjustment knobs driven by worms working in conjunction with worm gears, thus affecting an orientation of the media projector and an image or display projected from the media projector in a variety of directions with regard to yaw, pitch, and roll. Alternatively, lead screws can be utilized in place of the worms. In addition to easily adjusting the orientation of the projector mount, the projector mount only be adjusted via the plurality of adjustment knobs. For example, manually moving the media projector or the projector mount without utilizing the adjustment knobs is not possible. Because the adjustment of the media projector orientation within the projector mount can only be achieved using the plurality of adjustment knobs in conjunction with the worm gears, the orientation is more likely to remain fixed.

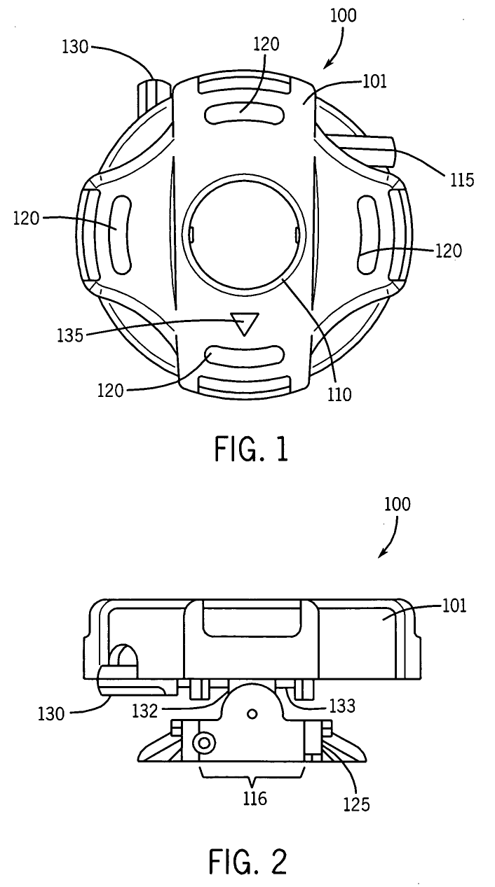

FIG. 1 shows a top view of a projector mount 100 constructed in accordance with the various embodiments of the present invention. As shown in FIG. 1, the projector mount 100 can be comprised of a plurality of elements, for example, a projector mount body 101, a captive screw 105, an extension column cavity 110, a roll adjustment knob 115, at least four yaw adjustment grooves 120 in one embodiment, a pitch adjustment knob 130, and a directional indicator 135. It should be noted that the directional indicator 135 is a substantially triangular and/or arrow-like indicator for indicating a frontwards orientation of the projector mount body 101. However, any shape can be utilized as a directional indicator and other orientations, e.g., sides and rear, can be indicated.

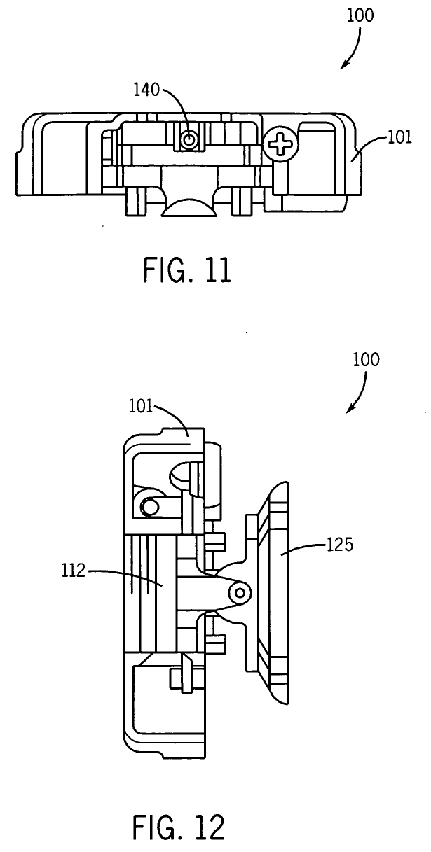

FIGS. 2, 3, 7, 10, 11, and 14 show additional elements which can be included as part of the projector mount 100, such as a connection block 125, an adapter 126 (one such adapter is disclosed in U.S. Design Pat. No. D513,470 which is incorporated herein by reference in its entirety), and a yaw lock screw 140. It should be noted that although the projector mount body 101 is shown to be substantially circular, the projector mount body 101 can also be configured as, but not limited to other shapes such as, a square, a rectangle, a triangle, etc. The shape of the projector mount body 101 can be altered as described to adapt to various mounting requirements. For example, if the mounting position of the projector mount 100 is at a corner of a ceiling, a triangularly shaped projector mount body 101 would allow the projector mount 100 to be mounted further “into” the corner than if the projector mount body 101 was circular.

The adapter 126 can be comprised of an adapter plate 127 and at least one connector channel 128. The adapter 126 functions as a mechanism for attaching various types of media projectors to the connection block 125. In FIG. 14, the media projector can be secured to the adapter plate 127 using four connector channels 128. The adapter plate 127 is in turn operatively engaged with the connection block 125. It should be noted that the although the shape of the adapter 126 is shown as being substantially circular, it could be configured with other shapes, as long as the adapter 126 can operatively engage the connection block 125 in the manner described above.

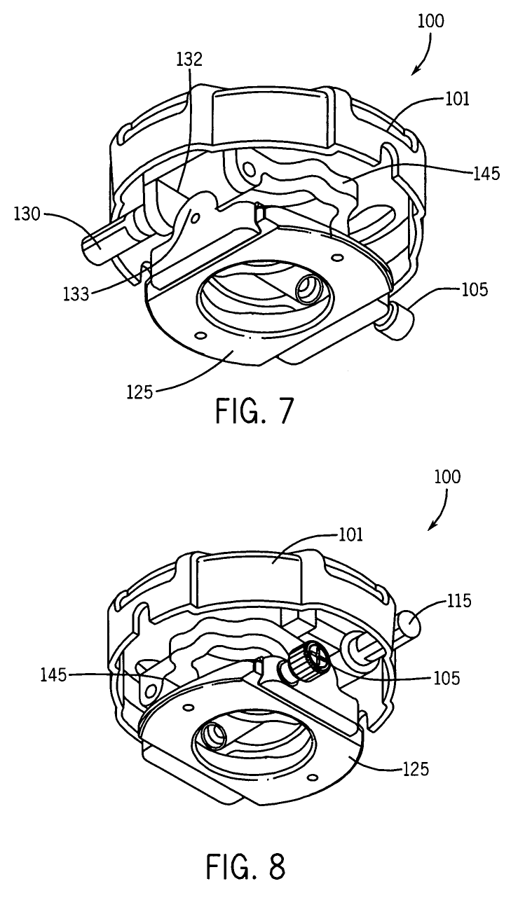

FIGS. 2 and 7 show how the pitch adjustment knob 130 can be used to achieve pitch adjustment. A user can rotate the pitch adjustment knob 130 in either one of two directions. In other words, the pitch adjustment knob 130 can be rotated about an axis substantially defined by the pitch adjustment rod 130. Rotating the pitch adjustment knob 130 results in the rotation of the pitch adjustment worm 132, thus engaging the pitch adjustment worm gear 133. It should be noted that the engaging of the pitch adjustment worm gear 133 by the pitch adjustment worm 132 can include a plurality of helical grooves, for example, that make up the pitch adjustment worm 132 frictionally contacting a surface of the pitch adjustment worm gear 133. Alternatively, the pitch adjustment worm gear 133 can be made up of plurality of teeth or spurs incorporated onto the surface of the pitch adjustment worm gear 133.

The pitch adjustment worm gear 133 is configured as a semicircular protrusion on the connection block 125 that, when engaged with the pitch adjustment worm 132, forces one side of the entire connection block 125 to be raised or lowered. It should be noted that the protrusion is not limited to being semicircular in shape, but can also be circular or any other appropriate shape. Rotating the pitch adjustment knob 130 in a first direction, for example, can force a front portion of the connection block 125 to be raised and a rear portion to be lowered, as indicated by arrow 116. Therefore, the connection block 125 is effectively canted to the rear. Rotating the pitch adjustment knob 130 in an opposite direction can force the front portion of the connection block 125 to be lowered and the rear portion to be raised, thus effectively canting the connection block 125 forward, as also indicated by the arrow 116. It should be noted that the pitch adjustment knob 130 can be set to raise or lower the front or rear portions of the connection block 125 depending on the helical orientation of the plurality of grooves comprising the pitch adjustment worm 132.

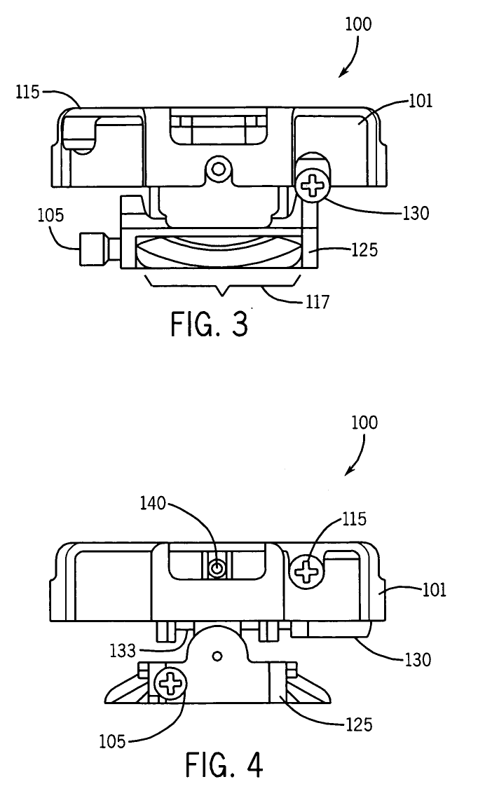

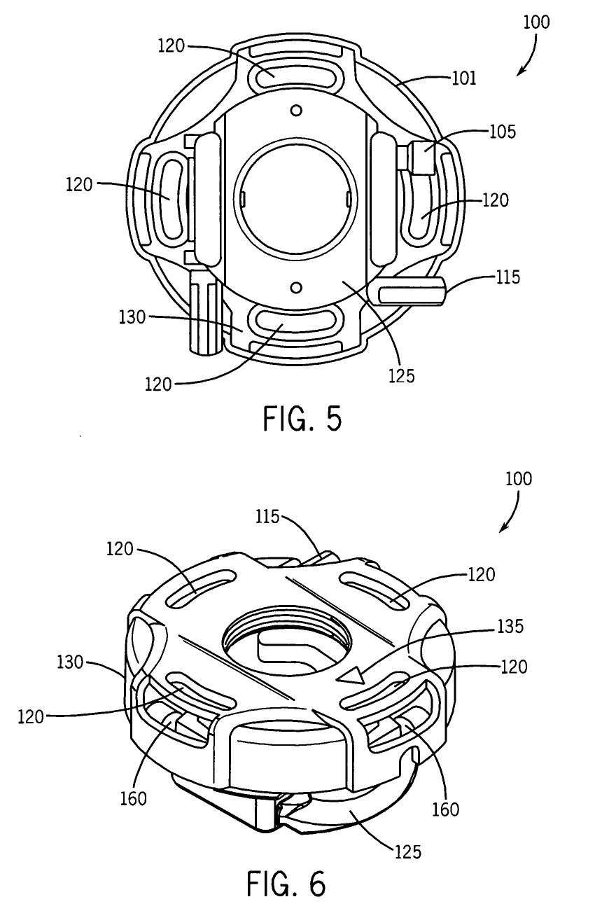

FIG. 5 shows that the roll adjustment knob 115 is oriented substantially perpendicular to the pitch adjustment knob 130. The roll adjustment knob 115 operates in conjunction with a roll adjustment worm (not shown) also oriented perpendicularly to the pitch adjustment worm 132. Like adjusting pitch as described above, rotating the roll adjustment knob 115 induces the roll adjustment worm to engage a roll adjustment worm gear (not shown). However, the movement induced by the rotation of the roll adjustment knob 115 results in the connection block 125 and a media projector connected thereto canting either to a leftward direction or to a rightward direction, as shown by arrow 117 in FIG. 3. Again, the direction of rotation necessary to cant the connection block 125 and the media projector towards the left or right merely depends on the helical orientation of grooves, for example, that make up the roll adjustment worm. In addition, FIG. 8 shows pivot points 145 about which the connection block 125 pivots to effectually perform the leftwards and rightwards canting of the connection block 125 and/or the media projector connected thereto.

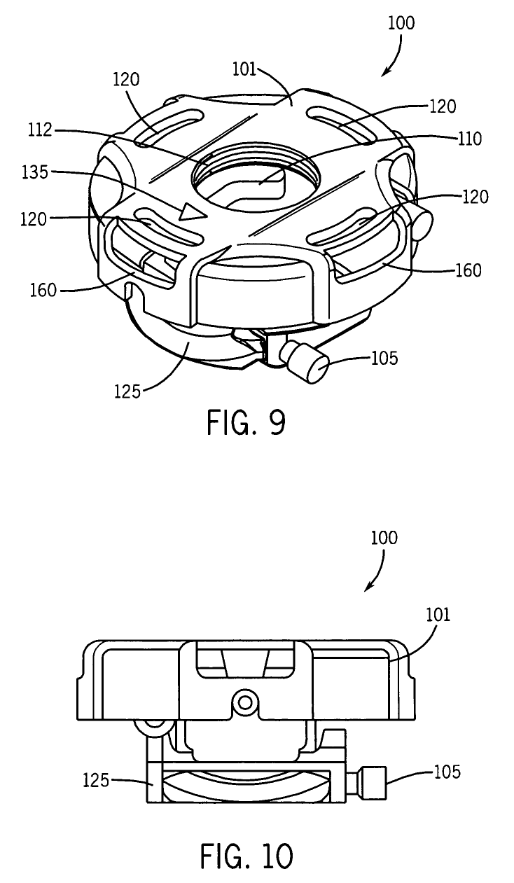

The various embodiments of the present invention utilize retractable knobs, such as pitch and roll adjustment knobs 130 and 115, respectively. Therefore, the pitch and roll adjustment knobs 130 and 115 remain in a retracted or “hidden” position when not being used to adjust pitch and roll as shown in FIGS. 1-12. However, when a user desires to adjust the pitch of the connection block 125, for example, the user pulls the pitch adjustment knob 130 in a direction substantially away from the projector mount body 101 and commences rotating the pitch adjustment knob 130. When the desired adjustments have been made, the pitch adjustment knob 130 can be put back to its retracted position. Therefore, a cleaner aesthetic is provided to the entire look of the projector mount 100. It should be noted that various mechanisms that allow for the retracting or hiding of the pitch and roll adjustment knobs 130 and 115 can be used. In addition, it should be noted that a tool can be used to operate the pitch and roll adjustment knobs 130 and 115 when they are in their respective, retracted positions.

FIGS. 1, 5, 6, and 9 illustrate how the various embodiments of the present invention allow for yaw adjustment, where yaw can refer to the swiveling or rotating of a media projector (not shown) about an axis defined by the extension column cavity 110. To adjust yaw, at least one fastener (not shown), in the form of a threaded rod in one embodiment, is secured through any one of the yaw adjustment grooves 120 to a ceiling or support structure. Therefore, the projector mount body 101 and therefore, the media projector connected thereto, can be manually rotated or swiveled by a user, allowing the at least one rod to travel within at least one of the yaw adjustment grooves 120. Greater yaw adjustment can be achieved by lengthening the yaw adjustment grooves 120. It should be noted that by utilizing the at least one rod, the projector mount 100 can be flush mounted to a ceiling or support structure because the at least one rod acts as a securing rod as well if the ceiling comprises a wood or other material penetrable by the at least one rod. Alternatively, if the ceiling is, for example, concrete, concrete anchors (not shown) can be utilized in conjunction with the at least one rod to secure the projector mount body 101 to the ceiling.

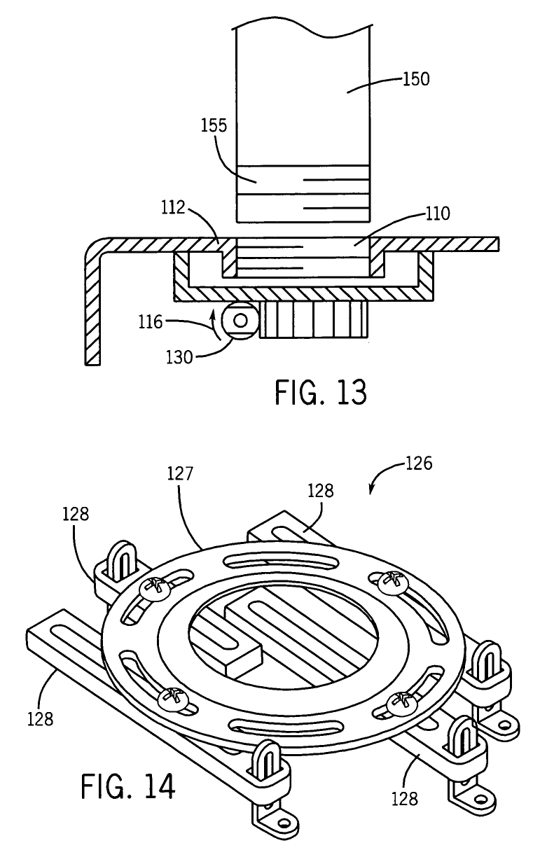

Alternatively, FIGS. 12 and 13 illustrate another method of mounting the projector mount 100 to a ceiling according to the various embodiments of the present invention. The projector mount body 101 is mounted to an extension column 150. As shown in FIG. 13, the extension column 150 is threaded, allowing it to be screwed into an extension column cavity 110 configured into the projector mount body 101. As shown in FIG. 13, the extension column cavity 110 includes a plurality of thread grooves 155 for accepting the extension column 150. The extension column 150 is then mounted in an appropriate manner to a ceiling, for example, a u-bolt ceiling mounting system. This allows the projector mount 100 to be secured to a ceiling truss, for example. When an extension column is utilized with the projector mount 100, a desired degree of yaw can be achieved simply by rotating the projector mount body 101 in relation to the extension column 150, i.e., threading more or less of the extension column 150 into the extension column cavity 110. Once the desired degree of yaw is achieved, the yaw lock screw 140 is tightened, thereby frictionally engaging the thread grooves 155 of the extension column 150 and preventing movement relative thereto.

FIGS. 2-4, 10, and 12 show various side views of the projector mount 100, respectively, while FIGS. 5, 7 and 8 show various bottom and perspective views of the projector mount 100. As illustrated, the connection block 125 is attached below the projector mount body 101 so that when the projector mount 100 is mounted to a ceiling or similar support structure, the projector mount body 101 is oriented between the ceiling and the connection block 125. In addition, the media projector can be attached to the adapter 126, where the adapter 126, in turn, can be secured to the connection block 125. This allows a media projector to be secured to the connection block 125 so that when the connection block 125 is attached to the projector mount body 101 as described above, the media projector also is oriented below the projector mount body 101. The connection block 125 can engage the projector mount body 101 for example, by being slid into a slot (not shown) configured to accept the connection block 125, although other methods of attaching the connection block 125 can be utilized. As described above, when a media projector is attached to the connection block 125 via the adapter 126, the slidable engagement feature allows the projector to be easily slid into and out of position. The connection block 125 can, in addition, be locked into position via a friction-actuated stop or lock, such as the captive screw 105, or another type of quick-release mechanism (not shown).

It should be noted that whenever a worm gear is used to provide pitch and roll adjustment, such adjustments can only be made by rotating the pitch and roll adjustment knobs 130 and 115. In other words, the pitch and roll adjustment gears engage the pitch and roll adjustment pinions, respectively, in such a way that manual adjustments, e.g., a user pushing or pulling the media projector, will not affect image alignment. Also, because of this engagement feature, no other setting or locking mechanism for maintaining a desired pitch or roll, is needed, although one can be utilized.

It should also be noted that all or some of the elements comprising the projector mount 100 described above can be cast, forged, or sintered out of a metal material, for example, aluminum, as opposed to being machined. Cast aluminum provides sufficient strength to secure most projectors to a ceiling, while being light enough in weight to allow for easy adjustment and installation of the projector mount 100. In addition, the aluminum can be painted, anodized, or treated with other appropriate coatings to blend in with the ceiling and/or other surrounding structures, as well as provide some measure of scratch resistance. Alternatively, other metallic and non-metallic material or materials and manufacturing processes can be used to construct the projector mount 100 and its various elements.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated. The features of the embodiments described herein may be combined in all possible combinations of methods, systems and devices.

What is claimed is:

1. A mounting system comprising:
a mount body configured to operatively connect to a ceiling surface;
a connection block operatively engaging a bottom portion of the mount body, wherein a media device can be attached to the connection block;
at least one of:
a pitch adjuster operatively engaging the connection block, the pitch adjuster comprising at least one of a first worm and a lead screw operatively engaging a first worm gear and allowing pitch adjustments to be made to the connection block relative to the mount body by hand,
a roll adjuster operatively engaging the connection block, the roll adjuster comprising at least one of a second worm and a second lead screw operatively engaging a second worm gear and allowing roll adjustments to be made to the connection block relative to the mount body by hand, and
a yaw adjustment mechanism incorporated into the mount body allowing yaw adjustments to be made to the mount body relative to the ceiling surface.

2. The system of claim 1, further comprising an extension column attached to the mount body at a first end, wherein a second end of the extension column distal from the first end is configured to attach to the ceiling surface.

3. The system of claim 2, wherein the yaw adjustments are achieved by rotating the mount body about the first end of the extension column.

4. The system of claim 1, wherein:
rotating the at least one of the first worm and the first lead screw in a first direction causes the first worm gear to rotate in a first perpendicular direction relative to the first direction about an axis substantially perpendicular to the at least one of the first worm and the first lead screw causing the connection block to forwardly cant to a desired degree; and
rotating the at least one of the first worm and the first lead screw in a second direction causes the first worm gear to rotate in a second perpendicular direction relative to the second direction about an axis substantially perpendicular to the at least one of the first worm and the first lead screw causing the connection block to backwardly cant to a desired degree.

5. The system of claim 4, wherein the pitch adjuster comprises a retractable pitch adjuster knob, and wherein the pitch adjustments are effectuated by pulling the retractable pitch adjuster knob in a third direction away from the mount body and rotating the retractable pitch adjuster knob in one of either the first and second directions.

6. The system of claim 1, wherein:
rotating the at least one of the second worm and the second lead screw in a first direction causes the second worm gear to rotate in a third perpendicular direction relative to the first direction about an axis substantially perpendicular to the at least one of the second worm and the second lead screw causing the connection block to cant in a leftward direction to a desired degree; and
rotating the at least one of the second worm and the second lead screw in a second direction causes the second worm gear to rotate in a fourth perpendicular direction relative to the second direction about an axis substantially perpendicular to the at least one of the second worm and the second lead screw causing the connection block to cant in a rightward direction to a desired degree.

7. The system of claim 6, wherein the roll adjuster comprises a retractable roll adjuster knob, and wherein the roll adjustments are effectuated by pulling the retractable roll adjuster knob in a third direction away from the mount body and rotating the retractable roll adjuster knob in one of either the first and second directions.

8. The system of claim 1, wherein the yaw adjustment mechanism comprises at least one groove incorporated into the mount body and at least one fastener inserted substantially perpendicularly through the at least one groove about which the mount body rotates securedly engage the ceiling structure.

9. The system of claim 8, wherein yaw adjustments are achieved by rotating the mount body relative to the ceiling structure so that the at least one fastener travels within the at least one groove in at least one direction.

10. The system of claim 8, wherein use of the at least one groove and the at least one fastener provide flush mounting of the mount body relative to the ceiling structure.

11. A media device, comprising:
a projector body;
a projector mount operatively engaging the projector body, the projector mount securedly attaching the projector body to a support structure;
at least one roll adjuster operatively coupled to the projector mount, the at least one roll adjuster comprising at least one of a first worm and a first lead screw operatively engaging a first worm gear, the at least one roll adjuster being actuatable by hand;
at least one pitch adjuster operatively coupled into the projector mount substantially perpendicular to the at least one roll adjuster, the at least one pitch adjuster comprising at least one of a second worm and a second lead screw operatively engaging a second worm gear, the at least one pitch adjuster being actuatable by hand; and
at least one yaw adjustment mechanism incorporated into the projector mount.

12. The media device of claim 11, wherein the at least one yaw adjustment mechanism comprises at least one groove incorporated into the projector mount and at least one fastener inserted substantially perpendicularly through the at least one groove about which the mount body rotates.

13. The media device of claim 11, further comprising an extension column attached to the projector mount at a first end, wherein a second end of the extension column distal from the first end is configured to attach to the support surface.

14. The media device of claim 13, wherein yaw adjustments are achieved by rotating the projector mount about the first end of the extension column.

15. The media device of claim 13, wherein the at least one pitch adjuster comprises a retractable pitch adjuster knob, and wherein pitch adjustments are effectuated by pulling the retractable pitch adjuster knob in a third direction away from the projector mount and rotating the retractable pitch adjuster knob in one of either the first and second directions.

16. A mounting system, comprising:
a media device;
a connection block operatively engaging the media device to support the media device therein;
a mount body slidably engaging the connection block in a bottom portion of the mount body, wherein the mount body securedly attaches to a ceiling surface;
at least one roll adjuster allowing roll adjustments to be made to the connection block relative to the mount body the at least one roll adjuster comprising at least one of a first worm and a first lead screw operatively engaging a first worm gear, the at least one roll adjuster being actuatable by hand;
at least one pitch adjuster allowing pitch adjustments to be made to the connection block relative to the mount body, the at least one pitch adjuster comprising at least one of a second worm and a second lead screw operatively engaging a second worm gear, the at least one pitch adjuster being actuatable by hand; and
at least one yaw adjustment mechanism allowing yaw adjustments to be made to the mount body.

17. The mounting system of claim 16, further comprising an extension column attached to the mount body at a first end, wherein a second end of the extension column distal from the first end is configured to attach to the ceiling surface.

18. The mounting system of claim 17, wherein yaw adjustments are achieved by rotating the mount body about the first end of the extension column.

19. The mounting system of claim 16, wherein the at least one yaw adjustment mechanism comprises at least one groove incorporated into the mount body and at least one fastener inserted substantially perpendicularly through the at least one groove about which the mount body rotates.

20. The mounting system of claim 16, wherein the at least one pitch adjuster comprises a retractable pitch adjuster knob, and wherein pitch adjustments are effectuated by pulling the retractable pitch adjuster knob in a third direction away from the mount body and rotating the retractable pitch adjuster knob in one of either the first and second directions.
